(19) United States
(12) Patent Application Publication
(10) Pub. No.: US 2011/0208494 A1
(43) Pub. Date: Aug. 25, 2011

(54) METHOD AND SYSTEM FOR SIMULATING A HANDLE'S MOTION

(75) Inventors: Jiangwei LI, Guangzhou (CN); Jie LIANG, Guangzhou (CN); Ming FENG, Beijing (CN); Ruyi LI, Beijing (CN); Xueliang CHEN, Guangzhou (CN); Yirong ZHUANG, Guangzhou (CN); Ge CHEN, Guangzhou (CH); Xiaomei HAN, Guangzhou (CN); Jinxia HAI, Guangzhou (CN)

(73) Assignee: CHINA TELECOM CORPORATION LIMITED, Beijing (CN)

(21) Appl. No.: 12/956,700

(22) Filed: Nov. 30, 2010

(30) Foreign Application Priority Data
Feb. 22, 2010 (CN) 201010113723.4

(51) Int. Cl. G06F 17/10; G06G 7/48

(52) U.S. Cl. 703/2; 703/6

(57) ABSTRACT

The present invention relates to a method and system for simulating a handle's motion. The method comprising: receiving detected acceleration values x(i), y(i) and z(i) of the handle in three directions; determining whether the acceleration values x(i), y(i) and z(i) in the three directions are noise interference with reference to a threshold value NT for noise interference; in the case that the acceleration values x(i), y(i) and z(i) are not the noise interference, determining angles α(i), β(i) and γ(i) during the handle's motion respectively from the acceleration values x(i), y(i) and z(i); and simulating the handle's motion on the basis of the angles α(i), β(i) and γ(i). The method and system according to the present invention poses a big challenge to the conventional operation by a mouse or a keyboard. They can simulate every motion of a user and reflect the motion on a role in a 3D game. It is also possible that virtual animation created by the method has outstanding reality and good real-time characteristics without additional hardware circuits, so that the user gets released from the restriction by the mouse and keyboard.

### TECHNICAL FIELD

The present invention relates to simulation of motion, and particularly to a method and system for simulating a handle's motion.

### BACKGROUND OF THE INVENTION

Nowadays, the following techniques are applied to acquire the motion tendency of an object.

(1) Motion Capturing Technique: The motion data of a moving body is directly captured by a sensor tracking device and used to create computer animation. The captured motion data records rich details of the body in motion. The virtual animation created from the captured motion data is strongly realistic and in good real-time. It has become a general technique for virtual animation to drive virtual motion with the motion data.

(2) Motion Sensing Technique: Motion sensing can be realized by video motion capturing, magnetic field motion capturing, photoelectrical motion capturing and the like. The magnetic field motion capturing and the photoelectrical motion capturing work basically with the principle of sensing of magnetic field and photoelectrical signals and are realized by advanced sophisticated hardware devices, while the video motion capturing captures the motion in each frame of image in real time using a method of image processing. However, a number of auxiliary devices are necessary to obtain omnidirectional sensation, and therefore entail a considerably high cost for an application which does not need omnidirectional sensation, such as, family entertainment.

(3) Bluetooth Virtual Imaging Game Control Technique: This technique acquires an analogue signal of human body's motion by using a sensor of a game handle, transforms the input analogue signal to a digital signal of human body's motion to be sampled and analyzed by a digital processing circuit, and transmits the analyzed data to the Bluetooth protocol stack to be processed. A host computer controls a human in a virtual scene by means of the data transmitted under the point-to-point Bluetooth protocol. This technique needs a number of complex digital circuits for signal processing, resulting in a time delay in real experience without an effect of real time.

The motion capturing technique has the best effect for sensing motion because it needs special sensors to acquire motion and entails a relatively large amount of data for reconstruction and modeling of a virtual human, although it is associated with relatively complex hardware and software processing. The motion sensing technique, as one of the emerging techniques nowadays, basically operates with the principle of sensing magnetic field and photoelectrical signals, and has not come into any commercial products. Generally, the above techniques have not yet been practically applied to motion simulation, for example, 3D gaming, due to their complex corollary equipments, relatively high costs and demanding requirement for operation.

### SUMMARY OF INVENTION

The present invention is designed to provide a method for simulating a handle's motion, thereby enabling outstanding reality and real-time characteristics with lower complexity and costs.

The present invention provides a method for simulating a handle's motion. The method comprises: receiving detected acceleration values x(i), y(i) and z(i) of the handle in three directions, wherein the three directions are an X axis, a Y axis and a Z axis in a coordinate system on a sensor for detecting the acceleration values; determining whether the acceleration values x(i), y(i) and z(i) in the three directions are noise interference with reference to a threshold value NT for noise interference; in the case that the acceleration values x(i), y(i) and z(i) in the three directions are determined not to be the noise interference, determining an angle α(i) of the X axis with respect to a y-z plane, an angle β(i) of the Y axis with respect to an x-z plane and an angle γ(i) of the Z axis with respect to an x-y plane during the handle's motion respectively from the acceleration values x(i), y(i) and z(i) in the three directions, wherein the y-z plane, the x-z plane and the x-y plane are planes in a coordinate system in a real space; and simulating the handle's motion on the basis of the angles α(i), β(i) and γ(i).

According to an embodiment of the present invention, the step of determining whether the acceleration values x(i), y(i) and z(i) in the three directions are noise interference with reference to a threshold value NT for noise interference comprises: determining whether a difference between the acceleration value x(i) and an acceleration value x(i−1) is less than the threshold value NT for noise interference; if the difference between the acceleration values x(i) and x(i−1) is determined to be less than the threshold value NT for noise interference, then determining whether a difference between the acceleration value y(i) and an acceleration value y(i−1) is less than the threshold value NT for noise interference; Otherwise, determining that the acceleration values x(i), y(i) and z(i) in the three directions are not the noise interference with respect to the acceleration values x(i−1), y(i−1) and an acceleration value z(i−1); if the difference between the acceleration values y(i) and y(i−1) is less than the threshold value NT for noise interference, then determining whether a difference between the acceleration values z(i) and z(i−1) is less than the threshold value NT for noise interference; otherwise, determining that the acceleration values x(i), y(i) and z(i) in the three directions are not the noise interference with respect to the acceleration values x(i−1), y(i−1) and z(i−1); and if the difference between the acceleration values z(i) and z(i−1) is less than the threshold value NT for noise interference, then determining that the acceleration values x(i), y(i) and z(i) in the three directions are the noise interference with respect to the acceleration values x(i−1), y(i−1) and z(i−1); otherwise, determining that the acceleration values x(i), y(i) and z(i) in the three directions are not the noise interference with respect to the acceleration values x(i−1), y(i−1) and z(i−1).

According to another embodiment of the present invention, the threshold value NT for noise interference ranges between 1 and 5.

According to yet another embodiment of the present invention, the step of determining an angle α(i) of the X axis with respect to a y-z plane, an angle β(i) of the Y axis with respect to an x-z plane and an angle γ(i) of the Z axis with respect to an x-y plane during the handle's motion respectively from the acceleration values x(i), y(i) and z(i) in the three directions comprises: calculating the angle α(i) of the X axis with respect to the y-z plane according to an equation:

$$α ( i ) = arccos ( \frac{( x ( i ) - x ( 0 ) )}{( x ( m ) - x ( 0 ) )} ) ,$$

in which x(0) is the acceleration value when the acceleration along the X axis forms an angle of 0 degree with respect to the y-z plane, x(m) is the acceleration value when the acceleration along the X axis forms an angle of 90 degrees with respect to the y-z plane, and x(i) is the acceleration value when the acceleration along the X axis forms an angle of α(i) with respect to the y-z plane;

calculating the angle β(i) of the Y axis with respect to the x-z plane according to an equation:

$$β ( i ) = arccos ( \frac{( y ( i ) - y ( 0 ) )}{( y ( m ) - y ( 0 ) )} ) ,$$

in which y(0) is the acceleration value when the acceleration along the Y axis forms an angle of 0 degree with respect to the x-z plane, y(m) is the acceleration value when the acceleration along the Y axis forms an angle of 90 degrees with respect to the x-z plane, and y(i) is the acceleration value when the acceleration along the Y axis forms an angle of β(i) with respect to the x-z plane; and

calculating the angle γ(i) of the Z axis with respect to the x-y plane according to an equation:

$$γ ( i ) = arccos ( \frac{( z ( i ) - z ( 0 ) )}{( z ( m ) - z ( 0 ) )} ) ,$$

in which z(0) is the acceleration value when the acceleration along the Z axis forms an angle of 0 degree with respect to the x-y plane, z(m) is the acceleration value when the acceleration along the Z axis forms an angle of 90 degrees with respect to the x-y plane, and z(i) is the acceleration value when the acceleration along the Z axis forms an angle of γ(i) with respect to the x-y plane.

According to still yet another embodiment of the present invention, before the step of determining an angle α(i) of the X axis with respect to a y-z plane, an angle β(i) of the Y axis with respect to an x-z plane and an angle γ(i) of the Z axis with respect to an x-y plane during the handle's motion respectively from the acceleration values x(i), y(i) and z(i) in the three directions, the method further comprises: determining whether the acceleration values x(i), y(i) and z(i) in the three directions are a backward acceleration. If any one of the acceleration values x(i), y(i) and z(i) is the backward acceleration, the acceleration values x(i) γ(i) and z(i) are discarded; otherwise, tendency of the handle's motion is determined based on the acceleration values x(i), y(i) and z(i).

The method for simulating a handle's motion according to the present invention poses a big challenge to the conventional operation by a mouse or a keyboard. The method can simulate every motion or action by a user who is operating the handle and reflect the motion or action on a role in a 3D game, for example. Moreover, it is possible that virtual animation created by the method has outstanding reality and good real-time characteristics without additional hardware circuits, so that the user gets released from the restriction by the mouse and keyboard.

The present invention is also designed to provide a system for simulating a handle's motion, thereby enabling outstanding reality and real-time characteristics with lower complexity and costs.

The present invention further provides a system for simulating a handle's motion. The system comprises: a data receiving block for receiving detected acceleration values x(i), y(i) and z(i) of a handle in three directions, wherein the three directions are an X axis, a Y axis and a Z axis in a coordinate system on a sensor for detecting the acceleration values; a noise interference determining block for determining whether the acceleration values x(i), y(i) and z(i) of the handle in the three directions received by the data receiving block are noise interference with reference to a threshold value NT for noise interference; a motion direction determining block for determining an angle α(i) of the X axis with respect to a y-z plane, an angle β(i) of the Y axis with respect to an x-z plane and an angle γ(i) of the Z axis with respect to an x-y plane during the handle's motion respectively from the acceleration values x(i), y(i) and z(i) in the three directions in the case that the noise interference determining block determines that the acceleration values x(i), y(i) and z(i) of the handle in the three directions are not the noise interference, wherein the y-z plane, the x-z plane and the x-y plane are planes in a coordinate system in a real space; and a motion simulation block for simulating the handle's motion on the basis of the angles α(i), β(i) and γ(i) determined by the motion direction determining block.

According to an embodiment of the present invention, the noise interference determining block comprises: an X-axis determining unit for determining whether a difference between the acceleration value x(i) and an acceleration value x(i−1) is less than the threshold value NT for noise interference; a Y-axis determining unit for determining whether a difference between the acceleration value y(i) and an acceleration value y(i−1) is less than the threshold value NT for noise interference; a Z-axis determining unit for determining whether a difference between the acceleration value z(i) and an acceleration value z(i−1) is less than the threshold value NT for noise interference; and an interference determining unit for determining that the acceleration values x(i), y(i) and z(i) in the three directions are the noise interference with respect to the acceleration values x(i−1), y(i−1) and z(i−1) if the difference between the acceleration values x(i) and x(i−1) is determined to be less than the threshold value NT for noise interference, the difference between the acceleration values y(i) and y(i−1) is determined to be less than the threshold value NT for noise interference, and the difference between the acceleration values z(i) and z(i−1) is determined to be less than the threshold value NT for noise interference; otherwise, determining that the acceleration values x(i), y(i) and z(i) in the three directions are not the noise interference with respect to the acceleration values x(i−1), y(i−1) and z(i−1).

According to another embodiment of the present invention, the threshold value NT for noise interference ranges between 1 and 5.

According to yet another embodiment of the present invention, the motion direction determining block comprises: an X-axis angle determining unit for calculating the angle α(i) of the X axis with respect to the y-z plane according to an equation:

$$α ( i ) = arccos ( \frac{( x ( i ) - x ( 0 ) )}{( x ( m ) - x ( 0 ) )} ) .$$

in which x(0) is the acceleration value when the acceleration along the X axis forms an angle of 0 degree with respect to the y-z plane, x(m) is the acceleration value when the acceleration along the X axis forms an angle of 90 degrees with respect to the y-z plane, and x(i) is the acceleration value when the acceleration along the X axis forms an angle of α(i) with respect to the y-z plane;

a Y-axis angle determining unit for calculating the angle β(i) of the Y axis with respect to the x-z plane according to an equation:

$$β ( i ) = arccos ( \frac{( y ( i ) - y ( 0 ) )}{( y ( m ) - y ( 0 ) )} ) ,$$

in which y(0) is the acceleration value when the acceleration along the Y axis forms an angle of 0 degree with respect to the x-z plane, y(m) is the acceleration value when the acceleration along the Y axis forms an angle of 90 degrees with respect to the x-z plane, and y(i) is the acceleration value when the acceleration along the Y axis forms an angle of β(i) with respect to the x-z plane; and

a Z-axis angle determining unit for calculating the angle γ(i) of the Z axis with respect to the x-y plane according to an equation:

$$γ ( i ) = arccos ( \frac{( z ( i ) - z ( 0 ) )}{( z ( m ) - z ( 0 ) )} ) ,$$

in which z(0) is the acceleration value when the acceleration along the Z axis forms an angle of 0 degree with respect to the x-y plane, z(m) is the acceleration value when the acceleration along the Z axis forms an angle of 90 degrees with respect to the x-y plane, and z(i) is the acceleration value when the acceleration along the Z axis forms an angle of γ(i) with respect to the x-y plane.

According to still yet another embodiment of the present invention, the system further comprises a handle device. The handle device comprises a three-axis acceleration sensor for detecting the acceleration values x(i), y(i) and z(i) of the handle device in the three directions and a data transmission block for transmitting the acceleration values x(i), y(i) and z(i) in the three directions detected by the three-axis acceleration sensor to the data receiving block.

According to still yet another embodiment of the present invention, the system further comprises a backward acceleration determining block for determining whether the acceleration values x(i), y(i) and z(i) in the three directions are a backward acceleration. If any one of the acceleration values x(i), y(i) and z(i) is the backward acceleration, the acceleration values x(i), y(i) and z(i) are discarded. Otherwise, tendency of the handle's motion is determined by the motion direction determining block.

The system for simulating a handle's motion according to the present invention poses a big challenge to the conventional operation by a mouse or a keyboard. The system can simulate every motion or action by a user who is operating the handle and reflect the motion or action on a role in a 3D game, for example. Moreover, it is possible that virtual animation created by the system has outstanding reality and good real-time characteristics without additional hardware circuits, so that the user gets released from the restriction by the mouse and keyboard.

### BRIEF DESCRIPTION OF DRAWINGS

The drawings depicted here are provided for an illustrative purpose and constitute a part of the application, in which

FIG. 1 is a flow chart illustrating a method for simulating a handle's motion according to an embodiment of the present invention;

FIG. 2 is a flow chart illustrating a method for simulating a handle's motion according to another embodiment of the present invention;

FIG. 3 is a block diagram of a system for simulating a handle's motion according to an embodiment of the present invention;

FIG. 4 is a block diagram of a system for simulating a handle's motion according to another embodiment of the present invention;

FIG. 5 is a block diagram of a system for simulating a handle's motion according to yet another embodiment of the present invention;

FIG. 6 is a block diagram of a system for simulating a handle's motion according to still yet another embodiment of the present invention; and

FIG. 7 is a block diagram of a system for simulating a handle's motion according to still yet another embodiment of the present invention.

### DETAILED DESCRIPTION OF EMBODIMENTS

Detailed description will be made below for the present invention with reference to the drawings in which exemplary embodiments are illustrated. The exemplary embodiments of the present invention are provided for an illustrative purpose without any undue limitation to the present invention.

Acceleration sensors operate according to the principle of inertia. Most of the acceleration sensors operate according to the principle of piezoelectric effect, which is a phenomenon where a force externally applied to a hemimorphic crystal without a symmetrical center changes the polarization of the crystal to create an electrical field inside the crystal in addition to deformation of the crystal. Such a phenomenon that a crystal is polarized with application of a mechanical force is called a positive piezoelectric effect. Generally, acceleration sensors rely on the characteristics of internal crystal deformation caused by acceleration. As the deformation effects an electrical voltage, it is possible to convert the acceleration to a voltage output provided that the relationship between the applied acceleration and the resulting voltage is known. Many other methods for providing an acceleration sensor are also available, for example, piezoresistivity, capacitive effect, hot bubble effect, photo effect or the like. Their basic principle is to measure and convert the amount of deformation of a medium generated by acceleration to a voltage output by relevant circuits.

The present invention utilizes a three-axis acceleration sensor chip. The angle and tendency of motion can be simulated with the acceleration values along three axes (i.e., an X axis, a Y axis and a Z axis) detected by the motion sensor chip. Thus the general state of motion can be sensed. Therefore, it is greatly advantageous in terms of costs and operability of games.

Note, there are two coordinate systems throughout the specification and claims. One is the coordinate system on the three-axis acceleration sensor chip with three coordinate axes denoted by capitalized letters X, Y and Z, and the other is the coordinate system in the real space with three coordinate axes denoted by lowercase letters x, y and z. Also, x-y, y-z and x-z planes are the planes in the coordinate system in the real space.

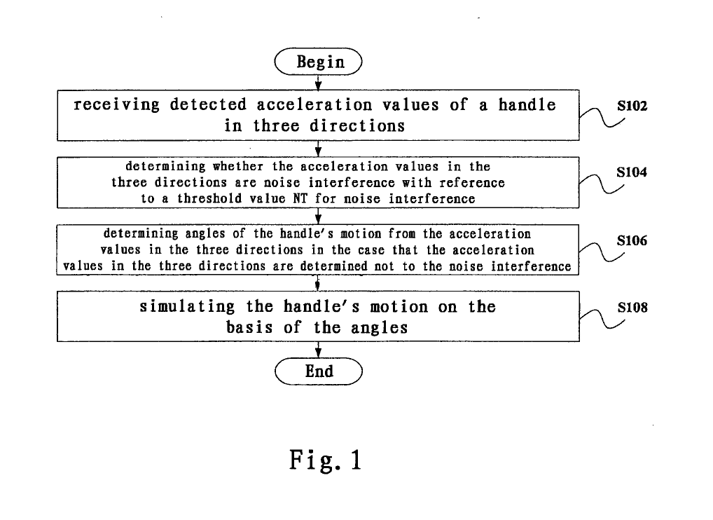

FIG. 1 is a flow chart illustrating a method for simulating a handle's motion according to an embodiment of the present invention.

As illustrated in FIG. 1, the embodiment comprises the steps as follows.

In the step of S102, the acceleration values x(i), y(i) and z(i) of a handle detected in three directions are received, where the three directions represent the X, Y and Z axes in the coordinate system on the three-axis acceleration sensor chip. For example, a three-axis acceleration sensor can be used to detect the acceleration values of the handle in the three directions.

In the step of S104, it is determined whether the acceleration values x(i), y(i) and z(i) in the three directions are noise interference with reference to a threshold value NT for noise interference which ranges between 1 and 5. Preferably, the threshold value NT for noise interference may be 2. For example, comparison is made between x(1) and x(2), between y(1) and y(2), and between z(1) and z(2). If the differences between three sets of values are all smaller than the threshold value NT for noise interference, x(2), y(2) and z(2) are determined as noises. Otherwise, x(2), y(2) and z(2) are determined not to be noises.

In the step of S106, in the case that the acceleration values x(i), y(i) and z(i) in the three directions are determined not to be noise interference, an angle α(i) of the X axis with respect to the y-z plane, an angle β(i) of the Y axis with respect to the x-z plane and an angle γ(i) of the Z axis with respect to the x-y plane during the handle's motion are determined respectively from the acceleration values x(i), y(i) and z(i) in the three directions. For example, if the acceleration value in the X axis is set as x(0) when the angle of the X axis with respect to the y-z plane is 0 degree and the acceleration value in the X axis is set as x(m) when the angle of the X axis with respect to the y-z plane is 90 degrees, then the angle α(i) of the X axis with respect to the y-z plane can be obtained from an equation,

$$α ( i ) = arccos ( \frac{( x ( i ) - x ( 0 ) )}{( x ( m ) - x ( 0 ) )} ) ,$$

when the acceleration value in the X axis is x(i). Likewise, the β(i) and γ(i) can also be obtained.

In the step of S108, the handle's motion is simulated on the basis of the angles α(i), β(i) and γ(i). For example, a rotatory motion effect of a role in the three-dimensional space can be obtained by using the space position transformation functions in the Direct3D (D3DXMatrixRotationX, D3DXMatrixRotationY and D3DXMatrixRotationZ).

In the state of art, either the cost for identification of motion is high, or the identifiable types of motion are few. The embodiment removes the defects in the state of art, enabling capturing of each action the user does via the handle without any additional hardware devices and improving the user's experience with lower costs. Moreover, the embodiment highly increases the real-time performance of simulation because it does not use a digital signal processing circuit to simulate the handle's motion.

In another embodiment of the method for simulating a handle's motion according to the present invention, it can be determined whether the acceleration values x(i), y(i) and z(i) in the three directions are noise interference with reference to the threshold value NT for noise interference through the following steps:
determining whether a difference between the acceleration value x(i) and an acceleration value x(i−1) is less than the threshold value NT for noise interference;
if the difference between the acceleration values x(i) and x(i−1) is determined to be less than the threshold value NT for noise interference, then determining whether the difference between the acceleration value y(i) and an acceleration value y(i−1) is less than the threshold value NT for noise interference; Otherwise, determining that the acceleration values x(i), y(i) and z(i) in the three directions are not the noise interference with respect to the acceleration values x(i−1), y(i−1) and an acceleration value z(i−1);
if the difference between the acceleration values y(i) and y(i−1) is less than the threshold value NT for noise interference, then determining whether the difference between the acceleration values z(i) and z(i−1) is less than the threshold value NT for noise interference; otherwise, determining that the acceleration values x(i), y(i) and z(i) in the three directions are not the noise interference with respect to the acceleration values x(i−1), y(i−1) and z(i−1);
if the difference between the acceleration values z(i) and z(i−1) is less than the threshold value NT for noise interference, then determining that the acceleration values x(i), y(i) and z(i) in the three directions are the noise interference with respect to the acceleration values x(i−1), y(i−1) and z(i−1); otherwise, determining that the acceleration values x(i), y(i) and z(i) in the three directions are not the noise interference with respect to the acceleration values x(i−1), y(i−1) and z(i−1).

In this embodiment, the threshold value NT for noise interference ranges between 1 and 5. It is preferable that this threshold value for noise interference is 2.

In this embodiment, the determination can be made in a different order. For example, the determination can be first made between the threshold value NT for noise interference and the difference between the acceleration values y(i) and y(i−1), and then between the threshold value NT for noise interference and the difference between the acceleration values x(i) and x(i−1) as well as the difference between the acceleration values z(i) and z(i−1). Alternatively, the determination can be first made between the threshold value NT for noise interference and the difference between the acceleration values z(i) and z(i−1), and then between the threshold value NT for noise interference and the difference between the acceleration values y(i) and y(i−1) as well as the difference between the acceleration values x(i) and x(i−1).

In this embodiment, it can be determined whether the currently received acceleration values are noises. If they are, the simulation for handle's motion will not be performed. Thereby the noise's influence on the simulation for handle's motion can be effectively removed.

In the method for simulating a handle's motion according to another embodiment of the present invention, the angle α(i) of the X axis with respect to the y-z plane, the angle β(i) of the Y axis with respect to the x-z plane and the angle γ(i) of the Z axis with respect to the x-y plane during handle's motion can be determined from the acceleration values x(i), y(i) and z(i) in the three directions through the following steps:
Calculating the angle α(i) of the X axis with respect to the y-z plane according to an equation:

$$α ( i ) = arccos ( \frac{( x ( i ) - x ( 0 ) )}{( x ( m ) - x ( 0 ) )} ) ,$$

in which x(0) is the acceleration value when the acceleration along the X axis forms an angle of 0 degree with respect to the y-z plane, x(m) is the acceleration value when the acceleration along the X axis forms an angle of 90 degrees with respect to the y-z plane, and x(i) is the acceleration value when the acceleration along the X axis forms an angle of α(i) with respect to the y-z plane;
Calculating the angle β(i) of the Y axis with respect to the x-z plane according to an equation

$$β ( i ) = arccos ( \frac{( y ( i ) - y ( 0 ) )}{( y ( m ) - y ( 0 ) )} ) ,$$

in which y(0) is the acceleration value when the acceleration along the Y axis forms an angle of 0 degree with respect to the x-z plane, y(m) is the acceleration value when the acceleration along the Y axis forms an angle of 90 degrees with respect to the x-z plane, and y(i) is the acceleration value when the acceleration along the Y axis forms an angle of β(i) with respect to the x-z plane;
Calculating the angle γ(i) of the Z axis with respect to the x-y plane according to an equation

$$γ ( i ) = arccos ( \frac{( z ( i ) - z ( 0 ) )}{( z ( m ) - z ( 0 ) )} ) ,$$

in which z(0) is the acceleration value when the acceleration along the Z axis forms an angle of 0 degree with respect to the x-y plane, z(m) is the acceleration value when the acceleration along the Z axis forms an angle of 90 degrees with respect to the x-y plane, and z(i) is the acceleration value when the acceleration along the Z axis forms an angle of γ(i) with respect to the x-y plane.

With this embodiment, it is possible to easily obtain the tendency of the handle's motion to enable simulation of the handle's motion in real time, resulting in improved user's experience.

In the method for simulating a handle's motion according to still another embodiment of the present invention, the method further includes a step of determining whether the acceleration values x(i), y(i) and z(i) in the three directions are a backward acceleration before the angle α(i) of the X axis with respect to the y-z plane, the angle β(i) of the Y axis with respect to the x-z plane and the angle γ(i) of the Z axis with respect to the x-y plane during handle's motion are respectively determined from the acceleration values x(i), y(i) and z(i) in the three directions. If any one of the acceleration values x(i), y(i) and z(i) is the backward acceleration, the acceleration values x(i), y(i) and z(i) are discarded. Otherwise, the tendency of the handle's motion is determined based on the acceleration values x(i), y(i) and z(i).

With this embodiment, the influence of the backward acceleration on the estimation of the motion tendency can be effectively eliminated, thereby resulting in a significantly increased accuracy of estimation of the motion tendency.

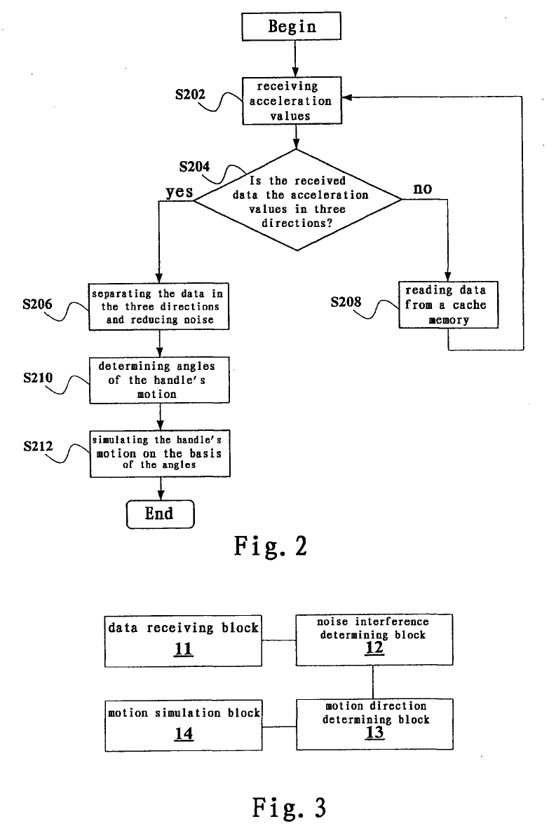

FIG. 2 is a flow chart illustrating the method for simulating a handle's motion according to another embodiment of the present invention.

The three-axis acceleration sensor chip generates consecutive data when a game player plays with a handle. The data can be processed and analyzed to obtain the acceleration values in the three directions generated by the chip. Then the tendency and angles of the handle's motion can be determined from those acceleration values in the three directions.

Next, a process for determining the motion tendency of the chip and simulating the motion tendency will be described with reference to FIG. 2.

In the step of S202, the acceleration values in the three directions of X, Y and Z axes detected by the three-axis acceleration sensor are received. For example, a set of real-time data transmitted by a Bluetooth transmission device can be obtained by using the functions in lower-level libraries of the COM components of C++.

In the step of S204, it is determined whether the received data is the acceleration values in the three directions.

In the step of S206, If the determination is positive, the acceleration values x(i), y(i) and z(i) along the X, Y and Z axes are obtained according to the data transmission protocol. Then noise reduction processing is performed on the resulting data in the three directions. That is, the data may be regarded as noise interference and the tendency of the handle's motion is not estimated if the differences between a value and the immediately preceding one along the X, Y and Z axes are all less than the threshold value NT for noise interference (e.g., 2). For example, if the differences between x(1) and x(2), between y(1) and y(2), and between z(1) and z(2) are all less than the threshold value NT for noise interference, x(2), y(2) and z(2) are determined as noises and the subsequent estimation will not be performed. Instead, if only the difference between x(1) and x(2) is less than the threshold value NT for noise interference, but the other differences are larger than the threshold value NT for noise interference, they are not determined as noise interference and the subsequent estimation will be performed.

In the step of S208, if the received data is not the acceleration values in the three directions, the process proceeds with reading data from a cache memory.

In the step of S210, the state and tendency of the handle's motion is determined on the basis of the acceleration values x(i), y(i) and z(i) in the three directions. Assuming the acceleration along the X axis as an example, x(0) is taken as a reference each time because x(0) is an initial value and an actual angle is calculated only when compared with the initial value. The specific process of calculation is described below. The angle of the X axis with respect to the y-z plane ranges from 0 to 90 degrees. The acceleration value along the X axis is assigned as x(0) when the angle is 0 degree, and the acceleration value along the X axis is assigned as x(m) when the angle is 90 degrees. In this case, the angle of the X axis with respect to the y-z plane is calculated by the following equation:

$$α ( i ) = arccos ( \frac{( x ( i ) - x ( 0 ) )}{( x ( m ) - x ( 0 ) )} ) .$$

Likewise, the angle of the Y axis with respect to the x-z plane is calculated by the following equation:

$$β ( i ) = arccos ( \frac{( y ( i ) - y ( 0 ) )}{( y ( m ) - y ( 0 ) )} ) ,$$

and the angle of the Z axis with respect to the x-y plane is calculated by the following equation:

$$γ ( i ) = arccos ( \frac{( z ( i ) - z ( 0 ) )}{( z ( m ) - z ( 0 ) )} ) .$$

Each of the user's actions may effect changes in the acceleration values in the three directions, of which one is dominant and the others are subordinate. A series of three values are plotted in a line graph from which the range and rule of the changing values can be apparently seen. Then the most dramatically changing value is selected as a dominant changing value. The tendency of motion is comprehensively determined according to this dominant changing value in view of the remaining two changing values.

In the step of S212, a rotatory motion effect of a role in the three-dimensional space can be obtained from the calculated angles α(i), β(i) and γ(i) by using the space position transformation functions in the Direct3D, such as, D3DXMatrixRotationX, D3DXMatrixRotationY and D3DXMatrixRotationZ.

With this embodiment, it is possible to realize relatively well capturing of motion with lower costs by using a three-axis acceleration sensor chip and sense the user's operations with the handle in real time by means of the captured data. Thus, it is possible for users to release themselves from restriction by pointing devices and keyboards to enjoy themselves by playing games freely.

Alternatively, this embodiment can consecutively read four sets of acceleration values and make determination with respect to the backward acceleration of the acceleration value in each direction before the state and tendency of motion is determined. The backward acceleration always happens following the acceleration in the forward direction and usually has a relatively large magnitude because the motion in the backward direction always occurs in an extremely short period. So, if the forward motion is regarded as a peak, the backward acceleration is a valley. Assuming that a valley immediately follows a peak (tests show that at most two waves exist between a valley representative of a backward acceleration and a previous peak, and this is the reason why four values are read), this valley can be identified as a backward acceleration. Instead, if the forward motion is regarded as a valley, then the backward acceleration is a peak. Accordingly, the peak can be identified as a backward acceleration. For an instance of the X axis, x(3), x(4), x(5) and x(6) are read. x(5) is assigned as the current value, x(3) and x(4) are two older values and x(6) is a new value. While making determination with respect to the backward acceleration, the current value x(5) is compared with two older values x(3) and x(4) as well as the new value x(6). It is possible to compare the magnitudes of accelerations as they are relative values. If x(5) is larger or less than x(3) x(4) and x(6) x(5) can be identified as a peak or a valley. Then the next set of four values is read. If a valley or a peak exists among the next set of data, it is determined that the four values read this time are influenced by the backward acceleration and the motion is ignored. If the current value x(5) is the backward acceleration, the estimation of the tendency of the handle's motion is not performed for the current value x(5) and the process proceeds with reading of the next set of values; otherwise the estimation of the tendency of the handle's motion is performed based on the current value. With the above process, it is possible to effectively eliminate the backward acceleration generated at the end of actions and improve the accuracy of simulation of the handle's motion.

FIG. 3 is a block diagram of a system for simulating a handle's motion according to an embodiment of the present invention.

As shown in FIG. 3, the system according to the embodiment includes a data receiving block 11 for receiving detected acceleration values x(i), y(i) and z(i) of a handle in three directions of the X, Y and Z axes; a noise interference determining block 12 for determining whether the acceleration values x(i), y(1) and z(i) of the handle in the three directions received by the data receiving block 11 are noise interference with reference to a threshold value NT for noise interference which ranges between 1 and 5 and is preferably 2; a motion direction determining block 13 for determining an angle α(i) of the X axis with respect to the y-z plane, an angle β(i) of the Y axis with respect to the x-z plane and an angle γ(i) of the Z axis with respect to the x-y plane during the handle's motion respectively from the acceleration values x(i), y(i) and z(i) in the three directions in the case that the noise interference determining block 12 determines that the acceleration values x(i), y(i) and z(i) of the handle in the three directions are not the noise interference; and a motion simulation block 14 for simulating the handle's motion on the basis of the angles α(i) β(i) and γ(i) determined by the motion direction determining block 13, for example, obtaining a rotatory motion effect of a role in the three-dimensional space through the space position transformation functions in the Direct3D (D3DXMatrixRotationX, D3DXMatrixRotationY and D3DXMatrixRotationZ).

In the state of art, either the cost for identification of motion is high, or the identifiable types of motion are few. This embodiment removes the defects in the state of art, enabling capturing of each action the user does via the handle without any additional hardware devices and improving the user's experience with lower costs. Moreover, the embodiment highly increases the real-time performance of simulation because it does not use a digital signal processing circuit to simulate the handle's motion.

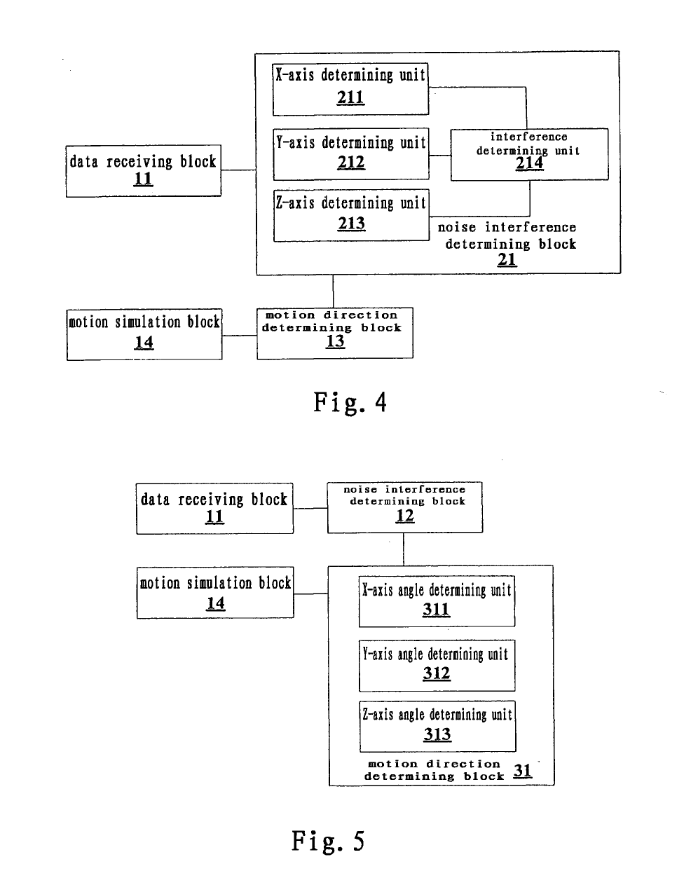

FIG. 4 is a block diagram of a system for simulating a handle's motion according to another embodiment of the present invention.

As shown in FIG. 4, referring to FIG. 3, the noise interference determining block 21 according to this embodiment includes an X-axis determining unit 211 for determining whether the difference between the acceleration values x(i) and x(i−1) is less than the threshold value NT for noise interference; a Y-axis determining unit 212 for determining whether the difference between the acceleration values y(i) and y(i−1) is less than the threshold value NT for noise interference; a Z-axis determining unit 213 for determining whether the difference between the acceleration values z(i) and z(i−1) is less than the threshold value NT for noise interference; an interference determining unit 214 for determining that the acceleration values x(i), y(i) and z(i) in the three directions are noise interference with respect to the acceleration values x(i−1), y(i−1) and z(i−1) if the difference between the acceleration values x(i) and x(i−1) is determined to be less than the threshold value NT for noise interference, the difference between the acceleration values y(i) and y(i−1) is determined to be less than the threshold value NT for noise interference, and the difference between the acceleration values z(i) and z(i−1) is determined to be less than the threshold value NT for noise interference; and determining, otherwise, that the acceleration values x(i), y(i) and z(i) in the three directions are not noise interference with respect to the acceleration values x(i−1), y(i−1) and z(i−1).

In this embodiment, the threshold value NT for noise interference ranges between 1 and 5. It is preferable that this threshold value for noise interference is 2.

With this embodiment, it is possible to determine whether the currently received acceleration values are noises and the simulation of handle's motion will not be performed if they are determined to be noise interferences. As a result, the influence of noise on the simulation of handle's motion can be effectively eliminated.

FIG. 5 is a block diagram of a system for simulating a handle's motion according to yet another embodiment of the present invention.

As shown in FIG. 5, also referring to FIG. 3, the motion direction determining block 31 according to this embodiment includes:

an X-axis angle determining unit 311 for calculating the angle α(i) of the X axis with respect to the y-z plane according to an equation,

$$α ( i ) = arccos ( \frac{( x ( i ) - x ( 0 ) )}{( x ( m ) - x ( 0 ) )} ) ,$$

in which the acceleration value x(0) is the acceleration value when the acceleration along the X axis forms an angle of 0 degree with respect to the y-z plane, x(m) is the acceleration value when the acceleration along the X axis forms an angle of 90 degrees with respect to the y-z plane, and x(i) is the acceleration value when the acceleration along the X axis forms an angle of α(i) with respect to the y-z plane;

a Y-axis angle determining unit 312 for calculating the angle β(i) of the Y axis with respect to the x-z plane according to an equation

$$β ( i ) = arccos ( \frac{( y ( i ) - y ( 0 ) )}{( y ( m ) - y ( 0 ) )} ) ,$$

in which the acceleration value y(0) is the acceleration value when the acceleration along the Y axis forms an angle of 0 degree with respect to the x-z plane, y(m) is the acceleration value when the acceleration along the Y axis forms an angle of 90 degrees with respect to the x-z plane, and y(i) is the acceleration value when the acceleration along the Y axis forms an angle of β(i) with respect to the x-z plane; and

a Z-axis angle determining unit 313 for calculating the angle γ(i) of the Z axis with respect to the x-y plane according to an equation

$$γ ( i ) = arccos ( \frac{( z ( i ) - z ( 0 ) )}{( z ( m ) - z ( 0 ) )} ) ,$$

in which the acceleration value z(0) is the acceleration value when the acceleration along the Z axis forms an angle of 0 degree with respect to the x-y plane, z(m) is the acceleration value when the acceleration along the Z axis forms an angle of 90 degrees with respect to the x-y plane, and z(i) is the acceleration value when the acceleration along the Z axis forms an angle of γ(i) with respect to the x-y plane.

With this embodiment, it is possible to easily acquire the tendency of the handle's motion to simulate the handle's motion in real time, so that the user's experience is improved.

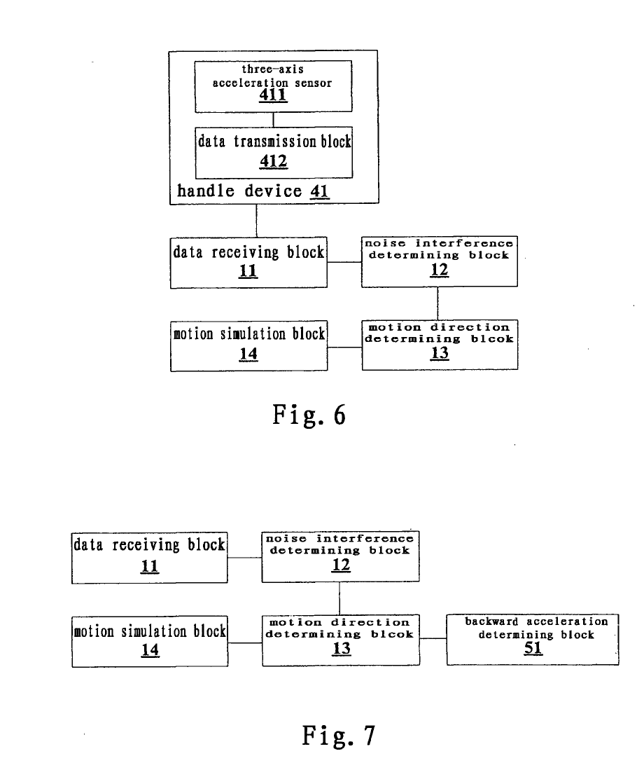

FIG. 6 is a block diagram of a system for simulating a handle's motion according to still yet another embodiment of the present invention.

As shown in FIG. 6, also referring to FIG. 3, the system according this embodiment further includes a handle device 41. The handle device 41 includes a three-axis acceleration sensor 411 for detecting the acceleration values x(i), y(i) and z(i) of the handle in the three directions; and a data transmission block 412 for transmitting the acceleration values x(i), y(i) and z(i) in the three directions detected by the three-axis acceleration sensor 411 to the data receiving block 11.

Here, the three-axis acceleration sensor 411 can detect three acceleration values in two horizontal directions and one vertical direction. The principal portion of the acceleration in the plane is the gravity acceleration. It is possible to calculate the tendency and state of the motion of the handle including the three-axis acceleration sensor 411 by determining the acceleration values of the three-axis acceleration sensor in the three directions. Then the data is transmitted by the data transmission block 412 to the data receiving block 11. Finally, a simulated three-dimensional animation effect can be realized by using the C++ programming language.

In this embodiment, data can be transmitted and received in compliance with the Bluetooth. That is, the data transmission block may be a Bluetooth adapter while the data receiving block may be a Bluetooth serial interface.

With this embodiment, a three-axis acceleration sensor is used to detect the acceleration values of the handle in three directions, resulting in an increased detection accuracy and considerably reduced costs.

FIG. 7 is a block diagram of a system for simulating a handle's motion according to still yet another embodiment of the present invention.

As shown in FIG. 7, also referring to FIG. 3, the system according to this embodiment further includes a backward acceleration determining block 51 for determining whether the acceleration values in the three directions are a backward acceleration. If any one of the acceleration values x(i), y(i) and z(i) is the backward acceleration, the acceleration values x(i), y(i) and z(i) is discarded; otherwise the tendency of the handle's motion is determined by the motion direction determining block 13.

With this embodiment, it is possible to eliminate the influence of the backward acceleration on the estimation for the tendency of motion, thereby significantly improving the accuracy of the estimation for the tendency of motion.

Moreover, the embodiment may be applied to the following scenarios. For example, if a sword is chosen as a weapon, the rotation of the handle can be represented by the sword. The detected angles of the handle in the three directions can be applied to the sword to enable the sword to rotate accordingly. For another example, assuming an aircraft as a body, the handle is used to control the flying direction and position of the aircraft. Similar to the three-dimensional thunder and lightening game, the handle can realize the movement in the left-right, up-down and forward-backward directions. The tendency of the handle's motion can be determined by a computer program to drive the aircraft to move accordingly.

In the above embodiments, a three-axis acceleration sensor chip of the ADXL330 type may be adopted with an average price of RMB 20-30 Yuan. In contrast, an action sensor handle available in the market costs hundreds of, even thousands of RMB Yuan. Therefore, the present invention is relatively advantageous over the existing products in terms of costs.

Furthermore, the above embodiments of the present invention are also capable of consecutively capturing actions. The changing angles of the handle with respect the individual planes are simulated on the basis of the changing acceleration values captured by the three-axis acceleration sensor during the motion. The changes are reflected on the object the handle is operating to effect consecutive motion of the object.

The above description of the invention is provided for an illustrative and exemplary purpose and is not intended to be exhaustive or limit the present invention to the disclosed forms. Many modifications and changes are apparent for a skilled person in the art. Selection and description of the embodiments is to better explain the principle and the practical applications of the invention and enable a skilled person to understand the invention and design various embodiments with various modifications suitable for specific usage.

What is claimed is:

1. A method for simulating a handle's motion, comprising:
receiving detected acceleration values x(i), y(i) and z(i) of the handle in three directions, wherein the three directions are an X axis, a Y axis and a Z axis in a coordinate system on a sensor for detecting the acceleration values;
determining whether the acceleration values x(i), y(i) and z(i) in the three directions are noise interference with reference to a threshold value NT for noise interference;
in the case that the acceleration values x(i), y(i) and z(i) in the three directions are determined not to be the noise interference, determining an angle α(i) of the X axis with respect to a y-z plane, an angle β(i) of the Y axis with respect to an x-z plane and an angle γ(i) of the Z axis with respect to an x-y plane during the handle's motion respectively from the acceleration values x(i), y(i) and z(i) in the three directions, wherein the y-z plane, the x-z plane and the x-y plane are planes in a coordinate system in a real space; and
simulating the handle's motion on the basis of the angles α(i), β(i) and γ(i).

2. The method of claim 1, wherein the step of determining whether the acceleration values x(i), y(i) and z(i) in the three directions are noise interference with reference to a threshold value NT for noise interference comprises:
determining whether a difference between the acceleration value x(i) and an acceleration value x(i−1) is less than the threshold value NT for noise interference;
if the difference between the acceleration values x(i) and x(i−1) is determined to be less than the threshold value NT for noise interference, then determining whether a difference between the acceleration value y(i) and an acceleration value y(i−1) is less than the threshold value NT for noise interference; Otherwise, determining that the acceleration values x(i), y(i) and z(i) in the three directions are not the noise interference with respect to the acceleration values x(i−1), y(i−1) and an acceleration value z(i−1);
if the difference between the acceleration values y(i) and y(i−1) is less than the threshold value NT for noise interference, then determining whether a difference between the acceleration values z(i) and z(i−1) is less than the threshold value NT for noise interference; otherwise, determining that the acceleration values x(i), y(i) and z(i) in the three directions are not the noise interference with respect to the acceleration values x(i−1), y(i−1) and z(i−1); and
if the difference between the acceleration values z(i) and z(i−1) is less than the threshold value NT for noise interference, then determining that the acceleration values x(i), y(i) and z(i) in the three directions are the noise interference with respect to the acceleration values x(i−1), y(i−1) and z(i−1); otherwise, determining that the acceleration values x(i), y(i) and z(i) in the three directions are not the noise interference with respect to the acceleration values x(i−1), y(i−1) and z(i−1).

3. The method of claim 1, wherein the threshold value NT for noise interference ranges between 1 and 5.

4. The method of claim 1, wherein the step of determining an angle α(i) of the X axis with respect to a y-z plane, an angle β(i) of the Y axis with respect to an x-z plane and an angle γ(i) of the Z axis with respect to an x-y plane during the handle's motion respectively from the acceleration values x(i), y(i) and z(i) in the three directions comprises:
calculating the angle α(i) of the X axis with respect to the y-z plane according to an equation:
$$α ( i ) = arccos ( \frac{( x ( i ) - x ( 0 ) )}{( x ( m ) - x ( 0 ) )} ) ,$$
in which x(0) is the acceleration value when the acceleration along the X axis forms an angle of 0 degree with respect to the y-z plane, x(m) is the acceleration value when the acceleration along the X axis forms an angle of 90 degrees with respect to the y-z plane, and x(i) is the acceleration value when the acceleration along the X axis forms an angle of α(i) with respect to the y-z plane;
calculating the angle β(i) of the Y axis with respect to the x-z plane according to an equation:
$$β ( i ) = arccos ( \frac{( y ( i ) - y ( 0 ) )}{( y ( m ) - y ( 0 ) )} ) ,$$
in which y(0) is the acceleration value when the acceleration along the Y axis forms an angle of 0 degree with respect to the x-z plane, y(m) is the acceleration value when the acceleration along the Y axis forms an angle of 90 degrees with respect to the x-z plane, and y(i) is the acceleration value when the acceleration along the Y axis forms an angle of β(i) with respect to the x-z plane; and
calculating the angle γ(i) of the Z axis with respect to the x-y plane according to an equation:
$$γ ( i ) = arccos ( \frac{( z ( i ) - z ( 0 ) )}{( z ( m ) - z ( 0 ) )} ) ,$$
in which z(0) is the acceleration value when the acceleration along the Z axis forms an angle of 0 degree with respect to the x-y plane, z(m) is the acceleration value when the acceleration along the Z axis forms an angle of 90 degrees with respect to the x-y plane, and z(i) is the acceleration value when the acceleration along the Z axis forms an angle of γ(i) with respect to the x-y plane.

5. The method of claim 1, before the step of determining an angle α(i) of the X axis with respect to a y-z plane, an angle β(i) of the Y axis with respect to an x-z plane and an angle γ(i) of the Z axis with respect to an x-y plane during the handle's motion respectively from the acceleration values x(i), y(i) and z(i) in the three directions, the method further comprising:
determining whether the acceleration values x(i), y(i) and z(i) in the three directions are a backward acceleration; and
if any one of the acceleration values x(i), y(i) and z(i) is the backward acceleration, discarding the acceleration values x(i), y(i) and z(i); otherwise, determining tendency of the handle's motion based on the acceleration values x(i), y(i) and z(i).

6. A system for simulating a handle's motion, comprising:
a data receiving block for receiving detected acceleration values x(i), y(i) and z(i) of a handle in three directions, wherein the three directions are an X axis, a Y axis and a Z axis in a coordinate system on a sensor for detecting the acceleration values;
a noise interference determining block for determining whether the acceleration values x(i), y(i) and z(i) of the handle in the three directions received by the data receiving block are noise interference with reference to a threshold value NT for noise interference;
a motion direction determining block for determining an angle α(i) of the X axis with respect to a y-z plane, an angle β(i) of the Y axis with respect to an x-z plane and an angle γ(i) of the Z axis with respect to an x-y plane during the handle's motion respectively from the acceleration values x(i), y(i) and z(i) in the three directions in the case that the noise interference determining block determines that the acceleration values x(i), y(i) and z(i) of the handle in the three directions are not the noise interference, wherein the y-z plane, the x-z plane and the x-y plane are planes in a coordinate system in a real space; and
a motion simulation block for simulating the handle's motion on the basis of the angles α(i) β(i) and γ(i) determined by the motion direction determining block.

7. The system of claim 6, wherein the noise interference determining block comprises:
an X-axis determining unit for determining whether a difference between the acceleration value x(i) and an acceleration value x(i−1) is less than the threshold value NT for noise interference;
a Y-axis determining unit for determining whether a difference between the acceleration value y(i) and an acceleration value y(i−1) is less than the threshold value NT for noise interference;
a Z-axis determining unit for determining whether a difference between the acceleration value z(i) and an acceleration value z(i−1) is less than the threshold value NT for noise interference; and
an interference determining unit for determining that the acceleration values x(i), y(i) and z(i) in the three directions are the noise interference with respect to the acceleration values x(i−1), y(i−1) and z(i−1) if the difference between the acceleration values x(i) and x(i−1) is determined to be less than the threshold value NT for noise interference, the difference between the acceleration values y(i) and y(i−1) is determined to be less than the threshold value NT for noise interference, and the difference between the acceleration values z(i) and z(i−1) is determined to be less than the threshold value NT for noise interference; otherwise, determining that the acceleration values x(i), y(i) and z(i) in the three directions are not the noise interference with respect to the acceleration values x(i−1), y(i−1) and z(i−1).

8. The system of claim 6, wherein the threshold value NT for noise interference ranges between 1 and 5.

9. The system of claim 6, wherein the motion direction determining block comprises:
an X-axis angle determining unit for calculating the angle α(i) of the X axis with respect to the y-z plane according to an equation:
$$α ( i ) = arccos ( \frac{( x ( i ) - x ( 0 ) )}{( x ( m ) - x ( 0 ) )} ) ,$$
in which x(0) is the acceleration value when the acceleration along the X axis forms an angle of 0 degree with respect to the y-z plane, x(m) is the acceleration value when the acceleration along the X axis forms an angle of 90 degrees with respect to the y-z plane, and x(i) is the acceleration value when the acceleration along the X axis forms an angle of α(i) with respect to the y-z plane;
a Y-axis angle determining unit for calculating the angle β(i) of the Y axis with respect to the x-z plane according to an equation:
$$β ( i ) = arccos ( \frac{( y ( i ) - y ( 0 ) )}{( y ( m ) - y ( 0 ) )} ) ,$$
in which y(0) is the acceleration value when the acceleration along the Y axis forms an angle of 0 degree with respect to the x-z plane, y(m) is the acceleration value when the acceleration along the Y axis forms an angle of 90 degrees with respect to the x-z plane, and y(i) is the acceleration value when the acceleration along the Y axis forms an angle of β(i) with respect to the x-z plane; and
a Z-axis angle determining unit for calculating the angle γ(i) of the Z axis with respect to the x-y plane according to an equation:
$$γ ( i ) = arccos ( \frac{( z ( i ) - z ( 0 ) )}{( z ( m ) - z ( 0 ) )} ) ,$$
in which z(0) is the acceleration value when the acceleration along the Z axis forms an angle of 0 degree with respect to the x-y plane, z(m) is the acceleration value when the acceleration along the Z axis forms an angle of 90 degrees with respect to the x-y plane, and z(i) is the acceleration value when the acceleration along the Z axis forms an angle of γ(i) with respect to the x-y plane.

10. The system of claim 6, further comprising a handle device,
wherein the handle device comprises:
a three-axis acceleration sensor for detecting the acceleration values x(i), y(i) and z(i) of the handle device in the three directions; and
a data transmission block for transmitting the acceleration values x(i), y(i) and z(i) in the three directions detected by the three-axis acceleration sensor to the data receiving block.

11. The system of claim 6, further comprising:
a backward acceleration determining block for determining whether the acceleration values x(i), y(i) and z(i) in the three directions are a backward acceleration;
wherein if any one of the acceleration values x(i), y(i) and z(i) is the backward acceleration, the acceleration values x(i), y(i) and z(i) are discarded; otherwise, tendency of the handle's motion is determined by the motion direction determining block.
